(19) United States
(12) Patent Application Publication
(10) Pub. No.: US 2021/0252640 A1
(43) Pub. Date: Aug. 19, 2021

(54) ADDITIVE MANUFACTURING SYSTEMS AND RELATED METHODS UTILIZING OPTICAL PHASED ARRAY BEAM STEERING

(71) Applicant: VulcanForms Inc., Burlington, MA (US)

(72) Inventor: Martin C. Feldmann, Somerville, MA (US)

(73) Assignee: VulcanForms Inc., Burlington, MA (US)

(21) Appl. No.: 17/165,080

(22) Filed: Feb. 2, 2021

Related U.S. Application Data
(60) Provisional application No. 63/113,103, filed on Nov. 12, 2020.
(60) Provisional application No. 62/978,111, filed on Feb. 18, 2020.

(51) Int. Cl. B23K 26/342; B23K 26/04; B23K 26/06; B23K 26/082; B23K 26/144; B23K 26/70; B33Y 10/00; B33Y 30/00; B33Y 50/02; B22F 10/28; B22F 12/45; B22F 10/366

(52) U.S. Cl. CPC B23K 26/342; B23K 26/043; B23K 26/0608; B23K 26/0643; B23K 26/0821; B23K 26/0626; B22F 10/366; B23K 26/703; B33Y 10/00; B33Y 30/00; B33Y 50/02; B22F 10/28; B22F 12/45; B23K 26/144

(57) ABSTRACT

Methods and systems for additive manufacturing are described. In one embodiment, laser energy is emitted from one or more laser energy sources, and a phase of the laser energy emitted by each of the laser energy sources is controlled to at least partially control a position of one or more laser beams directed towards a build surface. In some embodiments an optical phased array (OPA) is used to at least partially control the position and/or shape of the one or more laser beams on the build surface. Additionally, in some embodiments one or more mirror galvanometers and/or a moveable portion of a system may be used in coordination with one or more OPA assemblies.

### CROSS-REFERENCE TO RELATED APPLICATIONS

This application claims the benefit of priority under 35 U.S.C. § 119(e) of U.S. Provisional Application Ser. No. 63/113,103, filed Nov. 12, 2020, and U.S. Application Ser. No. 62/978,111, filed Feb. 18, 2020, the disclosures of each of which are incorporated by reference herein in their entirety.

### FIELD

Disclosed embodiments are related to additive manufacturing systems and methods that include one or more optical phased arrays for beam steering.

### BACKGROUND

Powder bed fusion processes are an example of additive manufacturing processes in which a three-dimensional shape is formed by selectively joining material in a layer-by-layer process. In metal powder bed fusion processes, one or multiple laser beams are scanned over a thin layer of metal powder. If the various laser parameters, such as laser power, laser spot size, and/or laser scanning speed are in a regime in which the delivered energy is sufficient to melt the particles of metal powder, one or more melt pools may be established on a build surface. The laser beams are scanned along predefined trajectories such that solidified melt pool tracks create shapes corresponding to a two-dimensional slice of a three-dimensional printed part. After completion of a layer, the powder surface is indexed by a defined distance, the next layer of powder is spread onto the build surface, and the laser scanning process is repeated. In many applications, the layer thickness and laser power density may be set to provide partial re-melting of an underlying layer and fusion of consecutive layers. The layer indexing and scanning is repeated multiple times until a desired three-dimensional shape is fabricated.

### SUMMARY

In one embodiment, an additive manufacturing system includes a build surface, one or more laser energy sources, and an optical phased array operatively coupled to the one or more laser energy sources. The optical phased array is constructed and arranged to direct laser energy emitted by the one or more laser energy sources towards the build surface. Also, the optical phased array includes one or more phase shifters operatively coupled to the one or more laser energy sources and configured to control a phase of the laser energy emitted by the one or more laser energy sources.

In another embodiment, an additive manufacturing system includes a build surface, a plurality of laser energy sources, and an optical phased array operatively coupled to the plurality of laser energy sources and constructed and arranged to direct laser energy emitted by the plurality of laser energy sources towards the build surface. The optical phased array includes a plurality of phase shifters, where each of the plurality of laser energy sources is operatively coupled to one or more of the plurality of phase shifters. Also, the plurality of phase shifters are configured to control a phase of laser energy emitted by the plurality of laser energy sources.

In another embodiment, a method for additive manufacturing includes: emitting laser energy from a plurality of laser energy sources; and controlling a phase of the laser energy emitted by each one of the plurality of laser energy sources to control a position of at least one laser beam directed towards a build surface.

In another embodiment, an additive manufacturing system includes a build surface, one or more laser energy sources configured to emit laser energy, an optical phased array operatively coupled to the one or more laser energy sources, and a mirror galvanometer assembly comprising one or more mirrors. The optical phased array includes one or more phase shifters operatively coupled to the one or more laser energy sources and configured to control a phase of the laser energy. The optical phased array is configured to direct the laser energy towards the mirror galvanometer assembly. The mirror galvanometer assembly is configured to direct the laser energy towards the build surface.

In another embodiment, a method for additive manufacturing includes emitting laser energy from a plurality of laser energy sources, controlling a phase of the laser energy emitted by each of the plurality of laser energy sources to control an angle of at least one laser beam relative to a build surface, and adjusting an angle of one or more mirrors to further control the angle of the at least one laser beam relative to the build surface.

In another embodiment, an additive manufacturing system includes a build surface, one or more laser energy sources configured to emit laser energy, an optical phased array operatively coupled to the one or more laser energy sources and configured to direct the laser energy towards the build surface, and a gantry assembly configured to adjust a position of the optical phased array relative to the build surface. The optical phased array includes one or more phase shifters operatively coupled to the one or more laser energy sources and configured to control a phase of the laser energy.

In another embodiment, a method for additive manufacturing includes emitting laser energy from a plurality of laser energy sources, controlling a phase of the laser energy emitted by each of the plurality of laser energy sources to control an angle of at least one laser beam relative to a build surface, and adjusting a position of the plurality of laser energy sources relative to the build surface.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of one embodiment of an additive manufacturing system including an optical phased array assembly;

FIG. 2 depicts one embodiment of an optical phased array assembly for use in an additive manufacturing system;

FIG. 3 depicts another embodiment of an optical phased array assembly for use in an additive manufacturing system;

FIG. 4 depicts yet another embodiment of an optical phased array assembly for use in an additive manufacturing system;

FIG. 5 depicts a further embodiment of an optical phased array assembly for use in an additive manufacturing system;

FIG. 6 depicts one embodiment of a mirror galvanometer assembly for use in an additive manufacturing system with an optical phased array;

FIG. 7 depicts one embodiment of a gantry assembly for use in an additive manufacturing system with an optical phased array; and

FIG. 8 depicts one embodiment of an additive manufacturing system including a micro lens array.

### DETAILED DESCRIPTION

The inventors have recognized and appreciated that additive manufacturing systems that utilize one or more optical phased arrays to steer one or more laser beams along a build surface (e.g., a powder bed) during an additive manufacturing process may provide numerous benefits compared to existing systems for directing laser energy towards a build surface. For example, some existing systems utilize mirrors to scan one or more laser spots. Such systems typically include an optical assembly including a laser (e.g., a fiber laser) that is directed onto two galvo mirrors that are each arranged for scanning along a single axis, thereby providing for two-dimensional scanning along a build surface. These systems may further include additional optical elements such as lenses (e.g., f-theta or telecentric lens assemblies, and/or autofocus units) that may dynamically adjust a focal length according to a current position of a laser spot on the build surface. However, the inventors have appreciated that these systems suffer from certain challenges that limit their usefulness in additive manufacturing processes. For instance, galvo-based systems may use large scanning assemblies associated with each laser beam that is scanned across the build surface. Increasing the number of lasers may result in an increase in the system complexity, which leads to reduced accuracy and repeatability, as well as increased cost. Consequently, systems that include a separate scanning assembly for each laser are typically limited to a small number of lasers (e.g., up to about 4 lasers), which limits the total amount of laser power that can be delivered to the build surface, and correspondingly limits the throughput of an associated additive manufacturing process.

Other existing approaches for scanning laser energy across a build surface may rely on gantries or similar structures that physically move one or more laser energy sources along one or more directions relative to the build surface to achieve a desired scanning pattern. Such systems may utilize closed loop positional feedback control, and thus can be highly accurate. Additionally, when utilizing an array based optical system, many laser energy sources can be placed next to one another in a small area and scanned together by moving the gantry. Accordingly, gantry-based approaches may allow for high positional accuracy and repeatability, as well as scalability to higher power levels compared to what is feasible with galvo-based approaches. However, the inventors have appreciated that gantry-based systems generally suffer from slow scanning speeds compared to galvo-based systems. For example, gantry-based systems may be limited to scanning speeds of up to a few meters per second, while galvo-based systems may be able to achieve scanning speeds of up to a few dozen meters per second. Consequently, despite the increased accuracy and power scaling, the overall throughput of an additive manufacturing process that relies solely on a gantry-based approach may be limited by slow scanning speeds.

In view of the foregoing, the inventors have recognized and appreciated numerous benefits associated with additive manufacturing systems that utilize one or more optical phased arrays configured to perform one or more aspects of beam steering during an additive manufacturing process. As used herein, an optical phased array (OPA) refers to an array of light emitters (e.g., laser emitters) arranged in a one or two dimensional array that each emit light having the same frequency. A phase shifter is associated with each emitter and, each phase shifter is configured to control the phase of the light emitted by its associated emitter. By controlling the phase of light emitted from each emitter, a beam formed from a superposition of light from the array of emitters can be steered and/or shaped on the build surface as desired. As described in more detail below, such control of the phase shifters may be performed at high frequencies, and thus an OPA may allow for high accuracy and high speed scanning of one or more laser beams without requiring any physical movement of the emitters.

According to some aspects, beam steering speeds achievable with an OPA may be orders of magnitude faster than those possible using a galvo- or gantry-based approach, which may enable generally higher throughput additive manufacturing processes, and also may enable scanning strategies that are not possible using existing galvo- or gantry-based approaches. For example, in some embodiments, a laser beam may be steered by an OPA on time scales that are much faster than those relevant to the kinetics of thermal transport and melting in a powder bed, and in this manner, a laser beam may be steered fast enough to effectively project an image of laser energy onto a build surface. Additionally, a laser beam may be shaped or otherwise controlled dynamically during an additive manufacturing process, such that the beam shape may be continually modified while scanning. This ability control a shape of the beam during a scanning operation to be a shape other than a Gaussian may be beneficial for different modes of weld formation. Additionally, an OPA-based beam steering system may enable an additive manufacturing process in which a large number of discrete melt pools may be formed simultaneously on the build surface without sacrificing feature resolution. Moreover, the high scanning speeds achievable using an OPA-based beam steering system may allow for laser power to be distributed as desired across the build surface, which may allow for more even heating of the part being formed. For example, the beam may be scanned such that no single spot is exposed to too much laser power (which may cause undesirable defects such as keyhole porosity or other effects).

While an OPA-based beam steering system may enable beam shaping as well as fast and accurate scanning, the area over which an OPA-based system scans may be limiting for certain applications. However, the inventors have recognized and appreciated the benefits associated with using an OPA in conjunction with other types of scanning arrangements. For example, in some embodiments, a galvo- or gantry-based system may be utilized to perform gross scanning at relatively slow speeds, while an OPA may be utilized for faster and/or finer scale scanning of a beam, as explained in more detail below. In one such embodiment, a plurality of laser sources may be coupled with one or more optical phased arrays and one or more galvanometer assemblies may be used to perform large scale scanning of the resulting patterns on the build surface at a size scale that is larger than a size scale of the scanning range of the associated OPA.

In some embodiments, an OPA may be arranged in series with a mirror galvanometer assembly, such that laser beams output from the OPA are directed toward the mirror galvanometer assembly. Small scale adjustments made by the OPA may be coordinated with large scale adjustments made by the mirror galvanometer assembly to enable highly accurate, high speed scanning of one or more laser beams over a large area.

A mirror galvanometer assembly may include one or more galvanometer-mounted mirrors configured to adjust an angle of a beam relative to a build surface. Actuating a galvanometer (or other suitable actuator) may adjust an angular position of an associated mirror, which may adjust an angle of a reflected beam and therefore a position of a beam spot on the build surface.

In some embodiments, a mirror galvanometer assembly includes a pair of galvanometer-mounted mirrors. Each mirror may be configured to control one dimension of a position of a laser beam spot on a build surface. For example, if a build surface is described by perpendicular x- and y-directions, a first mirror of a mirror galvanometer assembly may be associated with controlling a position of a laser beam spot along the x-direction of the build surface, and a second mirror of the mirror galvanometer assembly may be associated with controlling a position of the laser beam spot along the y-direction of the build surface such that the galvanometer assembly may control an overall position of a laser beam spot on the build surface. In some embodiments, the axes of rotations of the first and second mirrors may be perpendicular. It should be appreciated that, in some embodiments, a mirror galvanometer assembly may include additional mirrors, actuators, or optical elements, as the disclosure is not limited in this regard.

Each mirror of a mirror galvanometer assembly may be operatively coupled to an associated actuator configured to rotate the mirror, thereby adjusting the position of the laser beam spot along a respective dimension. For example, applying a first voltage to a first actuator associated with the first mirror may rotate the first mirror in a first angular direction, which may adjust a position of the laser beam spot in a first linear direction on the build surface. Applying a second voltage to the first actuator associated with the first mirror may rotate the first mirror in a second angular direction, which may adjust the position of the laser beam spot in a second linear direction on the build surface. In some embodiments, the second angular direction may be opposite the first angular direction. For example, the first angular direction may be clockwise, and the second angular direction may be counterclockwise. In some embodiments, the second linear direction may be opposite the first linear direction. For example, the first linear direction may be associated with the positive x-direction, and the second linear direction may be associated with the negative x-direction. Similarly, applying a third voltage to a second actuator associated with the second mirror may rotate the second mirror in a second angular direction, which may adjust the position of the laser beam spot in a third linear direction on the build surface. Applying a fourth voltage to the second actuator associated with the second mirror may rotate the second mirror in a fourth angular direction, which may adjust the position of the laser beam spot in a fourth linear direction on the build surface. In some embodiments, the fourth angular direction may be opposite the third angular direction. For example, the third angular direction may be clockwise, and the fourth angular direction may be counterclockwise. In some embodiments, the fourth linear direction may be opposite the third linear direction. For example, the third linear direction may be associated with the positive y-direction, and the fourth linear direction may be associated with the negative y-direction.

In some embodiments, a position of one or more optical phased arrays (OPAs) relative to a build surface may be controlled by a gantry assembly. For instance, a plurality of laser sources may be optically coupled to one or more OPAs disposed in an optical head attached to a moveable portion of a gantry, or other portion of a system that may be moved relative to an underlying build surface as the disclosure is not limited to how the one or more OPAs are moved relative to the build surface. Regardless of how the one or more OPAs are moved relative to the build surface, small scale adjustments made by the one or more OPAs may be coordinated with large scale adjustments made by the gantry assembly or other system used to move the optics head relative to the build surface to enable highly accurate, high speed scanning of one or more laser beams over a large area.

A gantry assembly may include one or more support rails. In some embodiments, support rails may be arranged perpendicularly. For example, in one embodiment, a gantry assembly may include four vertical support rails (e.g., aligned with a z-axis) extending above the build surface, and a pair of horizontal support rails (e.g., aligned with an x-axis) extending between the vertical support rails. A final horizontal support rail (e.g., aligned with a y-axis) may extend between the pair of horizontal support rails. In particular, a first horizontal support rail (aligned with the x-axis) may extend between first and second vertical support rails (aligned with the z-axis) and a second horizontal support rail (aligned with the x-axis) may extend between third and fourth vertical support rails (aligned with the z-axis). A third horizontal support rail (aligned with the y-axis) may extend between the first and second horizontal support rails (aligned with the x-axis).

Some support rails may be configured to translate relative to other support rails using translational attachments between the support rails. For example, a translation attachment between an end of a first support rail and a portion of a second support rail may enable the end of the first support rail to translate along a length of the second support rail.

In some embodiments, an OPA may be operatively coupled to a gantry assembly. For example, an OPA may be configured to translate along a first horizontal support rail. The first horizontal support rail may be configured to translate along one or more second horizontal support rails. The second horizontal support rails may be oriented perpendicular to the first horizontal support rails. For example, the first horizontal support rail may be aligned with a width of a build surface and the second horizontal support rails may be aligned with a length of the build surface. By translating the OPA along the first support rail and by translating the first support rail along the second support rails, a position of the OPA relative to the build surface may be controlled.

In some embodiments, an additive manufacturing system may include one or more laser energy sources coupled to an OPA. The OPA may be positioned over a build surface (e.g., a powder bed comprising metal or other suitable materials) of the additive manufacturing system and the OPA may be configured to direct laser energy from the one or more laser energy sources towards the build surface and scan the laser energy in a desired shape and/or pattern along the build surface to selectively melt and fuse material on the build surface. In some embodiments, a mirror galvanometer assembly may be positioned after or downstream of the OPA and configured to further adjust a position of the laser energy output from the OPA on the build surface. In some embodiments, a gantry assembly may be configured to control a position of the OPA relative to the build surface, and may be configured to further adjust a position of the laser energy output from the OPA on the build surface.

In some embodiments, an OPA may be formed from an array of optical fibers having emission surfaces directed towards a powder bed. For example, the array of optical fibers may have ends secured in a fiber holder constructed and arranged to maintain the fibers in a desired one or two dimensional pattern. However, it should be appreciated that an array of optical fibers may have emission surfaces directed in directions other than towards a powder bed, as the disclosure is not limited in this regard since a direction of light emitted by the fibers may be reoriented using one or more mirrors or other appropriate light directing component. In some instances, each optical fiber may be coupled to an associated laser energy source. Alternatively, one or more laser energy sources may be coupled to a splitting structure to couple laser energy from the laser energy sources to the array of optical fibers. Each optical fiber in the array of optical fibers may be coupled to an associated phase shifter though embodiments in which the laser energy emitted by the array of optical fibers is optically coupled to the associated phase shifters may also include free space optical connections as the disclosure is not limited to how the laser energy sources are coupled to the phase shifters. In some embodiments, the phase shifters may be piezoelectric phase shifters constructed and arranged to stretch a portion of an associated optical fiber in response to an electrical signal to change the phase of the laser energy emitted from the fiber. As described below, in some embodiments, a system may further include one or more sensors configured to detect a phase of laser energy emitted from each fiber in the array, which may be used in a feedback control system used to control one or more beams formed and scanned by the OPA.

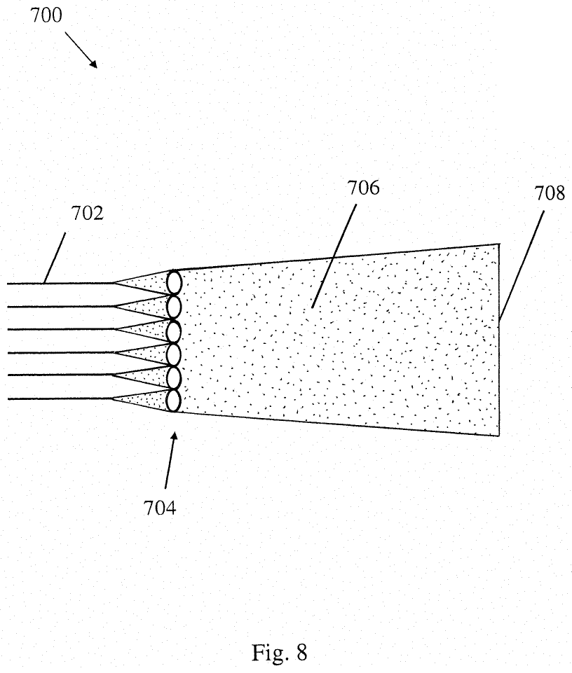

In some embodiments, an OPA may be formed using free-space phase shifters. For example, an array of laser energy pixels may be projected from an array of optical fibers. The array of laser energy may be directed, shaped, and/or focused towards an array of free space optical shifters using one or more mirrors, lenses, or other optical elements, and a phase of each laser energy pixel may be controlled when passing through the free-space phase shifter, such that a superposition of the phase-shifted laser energy pixels exiting the phase shifters forms one or more laser energy beams that is steered, shaped, and/or controlled as desired. Other possible components that might be included in a system with an OPA are further described relative to FIG. 8 below.

In some embodiments, one or more OPAs may be formed on a semiconductor substrate. For example, a semiconductor substrate (e.g., a silicon wafer) may have a plurality of waveguides formed thereon, and each waveguide may terminate in an emitter constructed and arranged to emit light (e.g., laser energy) from the semiconductor substrate. Depending on the particular embodiment, the emitters may be formed as so-called vertical emitters, such as grating emitters that emit light substantially perpendicular to the semiconductor substrate, or edge emitters that are configured to emit light out of an edge of the semiconductor substrate. In the case of edge emitters, in some embodiments, multiple edge-emitting structures may be stacked to form a two dimensional array. Moreover, each emitter may have an associated phase modulating structure formed on the semiconductor substrate, and the phase modulating structures may be controlled to control a phase of light emitted by each emitter, thereby allowing for control of the resulting beam(s) emitted by the OPA. The waveguides formed on the semiconductor substrate may be optically coupled to one or more light sources, such as one or more high power laser energy sources, and the waveguides may transmit the light through the semiconductor substrate to the emitters. In some instances, one or more splitting structures may be formed on the semiconductor substrate to divide light coupled to the semiconductor substrate among a plurality of emitters. It should be appreciated that the above-described semiconductor structures may be manufactured and arranged in any suitable manner. For example, lithographic processes as are known in the art may be used, though any appropriate method of manufacturing the described structures may be used as the disclosure is not so limited.

In some instances, an OPA formed on a semiconductor substrate may undesirably absorb heat while laser energy is transmitted through the waveguides and/or when the laser light is emitted from the emitters (e.g., due to transmission losses and/or emission of light towards the substrate). Such heat may result in damage to the semiconductor structures, especially at laser power levels suitable for additive manufacturing processes. Accordingly, in some embodiments, a semiconductor substrate having an OPA structure formed thereon may be coupled to a cooling structure, such as a heatsink or cooling plate that may be configured to actively cool the semiconductor substrate and OPA structures. For example, an OPA assembly, or a substrate (e.g. a semiconductor substrate) including a portion of the OPA assembly, may be mounted on the cooling structure.

According to some aspects, the inventors have appreciated that it may be desirable to control a spacing of emitters in an OPA. For example, and without wishing to be bound by any particular theory, it may be desirable to maintain a spacing between adjacent emitters to be approximately half of the wavelength of the light emitted from the OPA in order to reduce undesirable side or grating lobes that can form when emitters of a phased array are separated by larger distances. Accordingly, in some embodiments, an OPA according to the present disclosure may have an emitter spacing selected based on the wavelength of laser energy used in an additive manufacturing process. For example, in some instances, laser energy may have wavelength of approximately one micrometer, and thus an OPA may be configured to have emitters spaced approximately 0.5 microns from one another.

Depending on the particular embodiment, the phase shifters of an OPA may be operatively coupled to a controller configured to control the phase of light emitted by each emitter of the OPA. In some instances, each phase shifter may be capable of operating at very high frequencies, such as frequencies of hundreds of MHz to several GHz. Accordingly, the controller may be configured for sending high frequency control signals to operate the phase shifters and steer and/or shape one or more beams emitted by the OPA. For example, in some embodiments, a controller may include one or more field programmable gate array (FPGA) structures operatively coupled to the phase shifters. In one exemplary embodiment, an OPA formed on a semiconductor substrate may include one or more FPGA structures formed on the same semiconductor substrate and coupled to the phase shifters of the OPA via interconnects formed on the substrate. In this manner, the OPA and controller may be formed as a single integrated device on a semiconductor substrate. In some embodiments, one or more actuators of a mirror galvanometer assembly may be operatively coupled to a controller. In some embodiments, a single controller may be configured to control both an OPA and a mirror galvanometer assembly to coordinate the beam adjustments associated with the OPA and the beam adjustments associated with the mirror galvanometer assembly. In some embodiments, one or more actuators of a gantry assembly may be operatively coupled to a controller. In some embodiments, a single controller may be configured to control both an OPA and a gantry assembly to coordinate the beam adjustments associated with the OPA and the beam adjustments associated with the gantry assembly.

As used herein a controller may refer to one or more processors that are operatively coupled to non-transitory processor readable memory that includes processor executable instructions that when executed cause the various systems and components to perform any of the methods and processes described herein. It should be understood that any number of processors may be used such that the processes may be executed on a single processor or multiple distributed processors located at any appropriate location including either within an additive manufacturing system and/or at a location that is remote from the additive manufacturing system performing the desired operations as the disclosure is not limited in this fashion.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

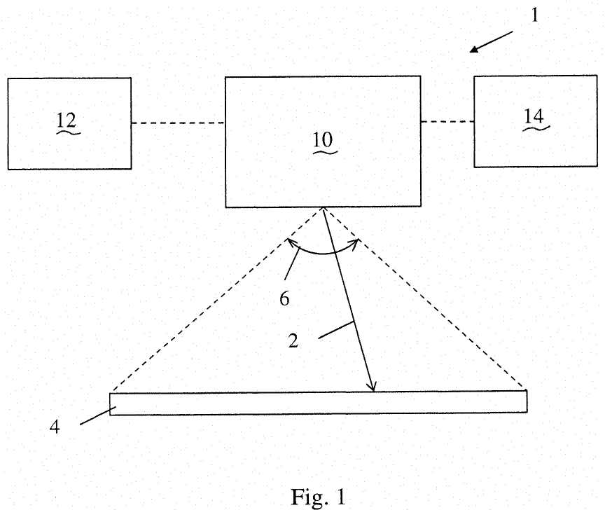

FIG. 1 is a schematic representation of one embodiment of an additive manufacturing system 1 including an OPA assembly 10 constructed and arranged to steer a laser energy beam 2 along a build surface 4. As illustrated, the OPA may be arranged to direct the beam within an angular scanning range 6, which may be up to 40 degrees, up to 60 degrees, up to 90 degrees, up to 120 degrees, up to 150 degrees or more. As, noted above, the OPA may steer the beam via control of high frequency phase shifters in the OPA, and thus an effective scanning speed on the beam on the build surface 4 may be greater than 10 m/s, greater than 50 m/s, greater than 100 m/s or more. As a result, the OPA may allow the beam to be scanned such that it defines an image or pattern that is effectively static on timescales relevant for powder fusion processes (e.g., melting and solidification of metal powder).

Given the relatively high speeds that a laser beam may be scanned across the surface of a powder bed, the formation process may function somewhat similarly to an electron beam based powder bed based machine. Specifically, one or more laser beams may be scanned across a powder bed in a pattern and at a speed such that one or more corresponding melt fronts do not proceed along the primary direction of motion of the one or more laser beams. Instead, the melt from may travel along the secondary direction of motion, i.e. in the direction of motion of the image being created by one or more beams being scanned across the powder bed. This may be beneficial as compared to typical laser based systems in that it may be possible to expose relative large areas, bring in more power than with a single spot, and provide more uniform thermal heating of the part being formed. However, while specific scanning speeds of a laser across a powder bed surface are mentioned above, scanning speeds both greater than and less than those noted above are contemplated as the disclosure is not limited in this fashion.

As illustrated, the OPA assembly 10 may be optically coupled to one or more laser energy sources 12 (e.g., via one or more optical cables), as well as operatively coupled to a controller 14 configured to control the phase shifters of the OPA to steer and/or shape the beam 2. As noted above, in some instances, the controller may comprise a high speed FPGA coupled to the phase shifters to enable high frequency operation and control of the OPA. Further, a controller as described herein may include one or more processors and associated non-transitory processor readable memory or other media storing instructions that when executed by the one or more processors may control the systems and components described herein to perform the disclosed methods and operations.

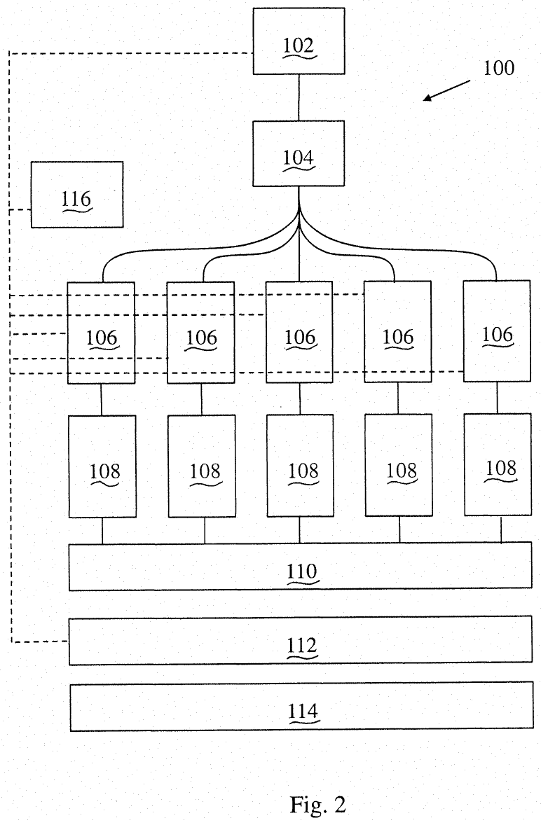

FIG. 2 depicts one embodiment of an OPA assembly 100 that may be used to direct laser energy onto a build surface of an additive manufacturing system. The system includes a laser energy source 102, which may be referred to as a seed laser. Laser energy is transmitted from the source 102 to a coupler 104 that splits the laser energy to a plurality of optical fibers which transmit the laser energy to a plurality of fiber phase shifters 106, such as piezoelectric fiber phase modulators stretchers arranged to stretch optical fibers to modulate a phase of the laser energy passing through the fibers. Prior to entering the phase shifters, the laser energy in each fiber, or that is transmitted along a different optical path, may be substantially in phase with one another and may have the same wavelength, or range of wavelengths. Once the laser energy passes through the phase shifters, the modulated (i.e., phase shifted) laser energy is then transmitted through a plurality of amplifiers 108 configured to amplify the power of the laser energy to a desired power level (e.g., a power level suitable for a powder fusion process). Ends of the optical fibers coming out of the amplifiers 108 are received in a fiber holder 110, which may be constructed and arranged to arrange the fiber ends to form a desired pattern of laser energy emitters, such as a one or two dimensional array. The fiber holder may be constructed in any appropriate fashion to arrange the fibers in a desired pattern. For example, a plate, or other structure may include a plurality of precision drilled holes that the optical fibers may be individually connected to in order to arrange the optical fibers in the desired pattern, though other constructions of a fiber holder may also be used as the disclosure is not so limited. In some embodiments the fibers may include multiple cores which may further decrease the emitter spacing in some applications.

In some embodiments, the OPA assembly may further include a phase detector 112 to detect a phase of laser energy emitted from the optical fibers held in the fiber holder 110, which may be used in a feedback control system as noted below. Depending on the embodiment, the feedback control may either be implemented using one or more sensors located internal or external to the OPA assembly as the disclosure is not limited to how the feedback control is implemented. Moreover, in some embodiments, laser energy transmitted out of the fiber holder 110 may pass through one or more optical elements 114 such as lenses before being directed to a build surface. As illustrated, a controller 116 is coupled to the laser energy source 102, the phase shifters 106, and the phase detector. The control may control operation of each of these components to achieve a desired shape and/or pattern of laser energy that is emitted towards a build surface from the fiber holder 110 and through the optical elements 114 (if included). In some embodiments, the controller may utilize an active feedback scheme to control the phase of laser energy passing through each phase shifter 106 based on the phase measured with the detector 112.

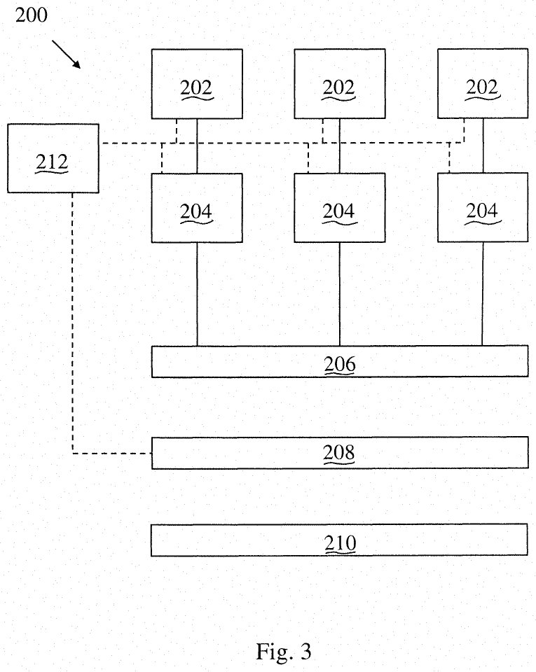

FIG. 3 depicts another embodiment of an OPA assembly 200. Similar to the embodiment described previously, the OPA assembly 200 includes a fiber holder 206 constructed and arranged to hold ends of optical fibers in a desired pattern of laser energy emitters, such as a one or two dimensional array. However, in this embodiment, each emitter of the array has an associated laser energy source 202, rather than utilizing a single laser energy source that is subsequently split. In particular, the OPA assembly 200 includes a plurality of laser energy sources 202 which are coupled to phase shifters 204, and subsequently to the fiber holder 206. Similar to the above-described embodiment, a phase detector 208 may detect a phase of laser energy emitted from the emitters held in the fiber holder 208 for use in a feedback control scheme, and the assembly may further include one or more optical elements 210 between the fiber holder 206 and a build surface. Moreover, a controller 212 is operatively coupled to the laser energy sources 202, phase shifters 204, and phase detector 208.

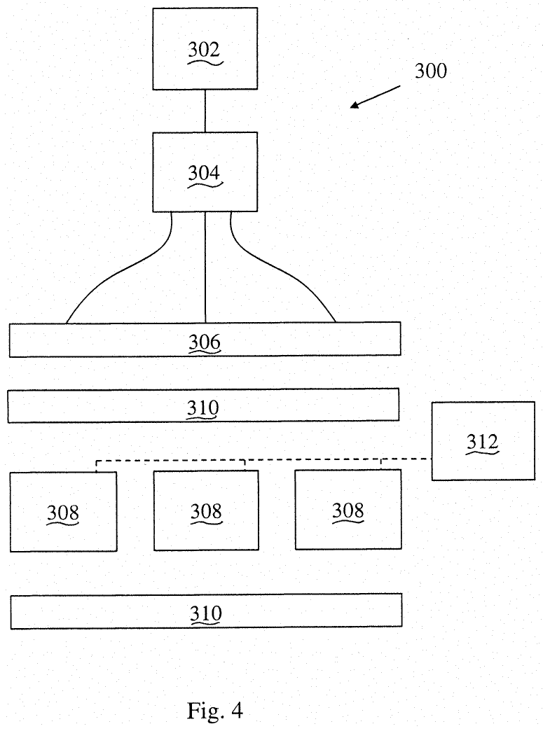

FIG. 4 depicts a further embodiment of an OPA assembly 300. In this embodiment, laser energy from a laser energy source 302 is split and coupled to a fiber holder 306 via a coupler 304. Similar to the embodiments described above, the fiber holder may define an array of laser energy emitters. In this embodiment, laser energy may be emitted from the array of emitters and subsequently pass through a plurality of free-space phase shifters 308 configured to modulate the phase of the laser energy and steer and/or shape a resulting beam of laser energy. As illustrated, the phase shifters may be positioned between optical elements 310 such as lenses that may focus and/or direct the laser energy from the fiber holder 306 into the phase shifters 308. In some instances, these optical elements may be configured to shape the laser energy emitted from the fiber holder 306 to reduce a spacing between adjacent laser energy wavefronts emitted from the fiber holder prior to undergoing phase shifting via the free space phase shifters 308. In some cases, the spacing may be reduced to about one half of the wavelength of the laser energy, which may aid in reducing undesirable side lobes as discussed above. The phase shifters 308 may be operatively coupled to a controller 312 to control the phase of the laser energy passing through each phase shifter to steer and/or shape a resulting laser energy beam. In some instances, one or more additional optical elements 310 may be positioned after the phase shifters.

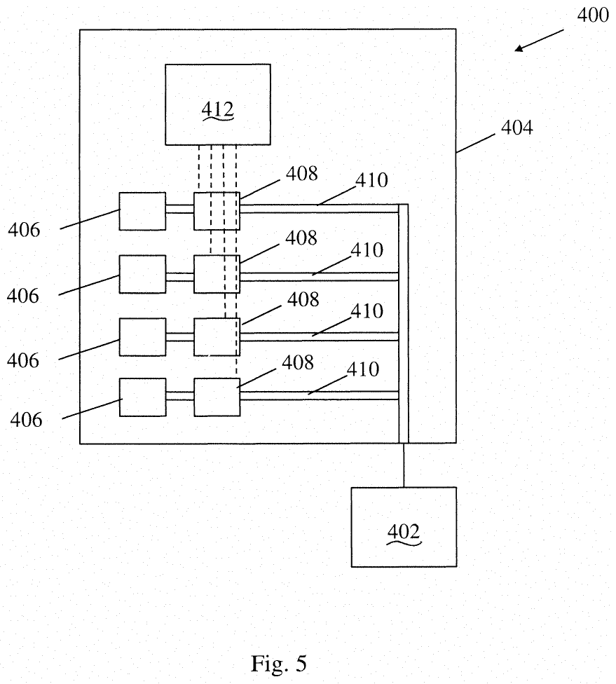

FIG. 5 depicts yet another embodiment of an OPA assembly 400 which may be utilized in an additive manufacturing system. In this embodiment, the OPA is formed on a semiconductor substrate, such as a silicon wafer. In this embodiment, laser energy from a laser energy source 402 is coupled to a semiconductor substrate 404, and the laser energy is transmitted to a plurality of emitters 406 formed on the substrate 404 via waveguides 410 formed on the substrate. For example, the emitters 406 may be configured as grating emitters configured to emit the laser energy in a direction that is substantially normal to a plane and/or surface of the substrate. Before reaching the emitters, the laser energy may be transmitted through a plurality of phase modulators 408 formed on the semiconductor substrate, and the phase modulators may be operatively coupled to a controller 412. In some instances, the controller also may be formed on the semiconductor substrate, such that the OPA assembly 400 may be formed as a single integrated component.

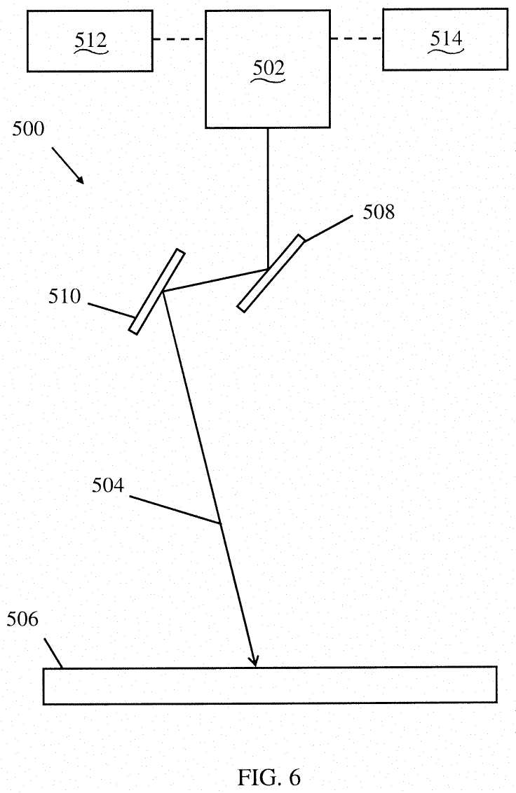

FIG. 6 depicts one embodiment of a mirror galvanometer assembly 500 for use in an additive manufacturing system with an optical phased array. A beam 504 output from an OPA assembly 502 may be directed toward the mirror galvanometer assembly 500. A first mirror 508 of the mirror galvanometer assembly 500 may be operatively coupled to a first actuator (not shown). Actuating the first actuator may rotate the first mirror 508 about a first axis to adjust a first angle of the beam 504 relative to a build surface 506. After the beam 504 reflects off of the first mirror 508, it may be directed to a second mirror 510, which may be operatively coupled to a second actuator (not shown). Actuating the second actuator may rotate the second mirror 510 about a second axis to adjust a second angle of the beam 504 relative to the build surface 506. In some embodiments, the first and second axes may be perpendicular, such that the first mirror 508 and the second mirror 510 control perpendicular dimensions of a beam spot on the build surface 506. It should be appreciated that although only a single beam 504 is depicted in the figure, any suitable number of beams arranged in any suitable arrangement may be used with an additive manufacturing system featuring an OPA and a mirror galvanometer assembly, as the disclosure is not limited in this regard. Additionally, while a single OPA and associated mirror galvanometer assembly are depicted, an additive manufacturing system may include any appropriate number of OPAs and associated mirror galvanometer assemblies that are used to coordinate large-scale scanning of the patterns output by the individual OPAs over a build surface of the additive manufacturing system.

The OPA assembly 502 may be optically coupled to one or more laser energy sources 512 (e.g., via one or more optical cables), as well as operatively coupled to a controller 514 configured to control the phase shifters of the OPA to steer and/or shape the beam 504. The controller 514 may be additionally coupled to the actuators associated with the first mirror 508 and the second mirror 510. As noted above, in some instances, the controller may comprise a high speed FPGA coupled to the phase shifters to enable high frequency operation and control of the OPA. Further, a controller as described herein may include one or more processors and associated non-transitory processor readable memory or other media storing instructions that when executed by the one or more processors may control the systems and components described herein to perform the disclosed methods and operations.

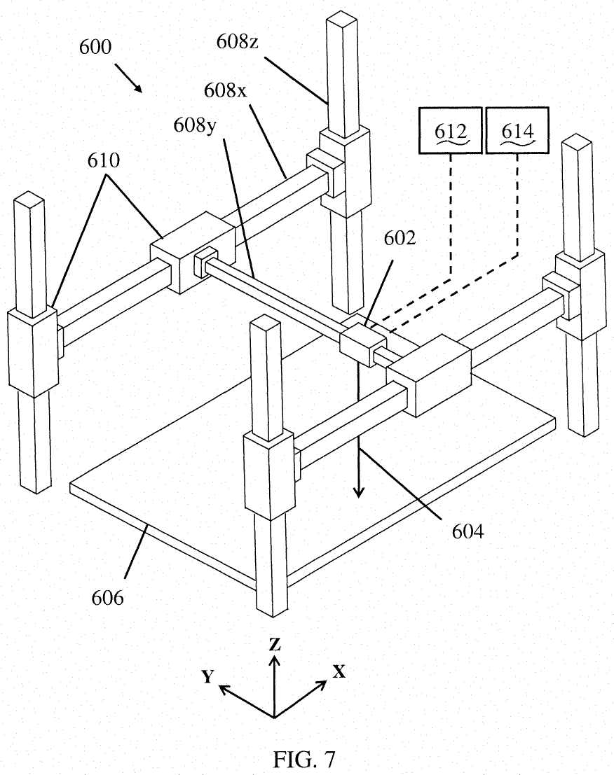

FIG. 7 depicts one embodiment of a gantry assembly 600 for use in an additive manufacturing system with an optical phased array. A patterned beam 604 may be output from an OPA assembly 602 and directed toward a build surface 606. The OPA assembly 602 may be coupled to the gantry assembly 600, which may be configured to control a position of the OPA assembly 602 relative to the build surface 606. For example, the OPA assembly 602 may be configured to translate along a first horizontal support rail 608y, which may adjust a position of the OPA assembly along the y-axis. The first horizontal support rail 608y may in turn be configured to translate along a pair of second horizontal support rails 608x, which may adjust a position of the OPA assembly along the x-axis. In some embodiments, the pair of second horizontal support rails 608x may be configured to translate along vertical support rails 608z, which may adjust a position of the OPA assembly along the z-axis. It should be appreciated that although only a single beam 604 is depicted in the figure, any suitable number of beams arranged in any suitable arrangement may be used with an additive manufacturing system featuring an OPA and a gantry assembly, as the disclosure is not limited in this regard. For example, embodiments in which a plurality of OPA assemblies are disposed on the movable portion of the system, such as an optics head or other moveable portion of a system including multiple OPA assemblies, may be used. Accordingly, the plurality of OPA assemblies may be moved with the optics head or other movable portion of the system relative to the build surface on a size scale that is greater than a scanning range of the individual OPA assemblies. Accordingly, it should be understood that the current disclosure is not limited to any specific number of OPA assemblies.

In some embodiments, the gantry assembly 600 may include multiple support rails 608 and multiple translational attachments 610. Support rails 608 may be arranged perpendicularly. For example, support rails may be aligned with an x-axis, a y-axis, or a z-axis. Some support rails 608 may be configured to remain stationary relative to the build surface 606, while other support rails 608 may be configured to move relative to the build surface 606. For example, support rails 608z aligned with a vertical axis (e.g., the z-axis depicted in the figure) may be configured to remain stationary, while support rails 608x and 608y aligned with a horizontal axis (e.g., the x-axis or the y-axis depicted in the figure) may be configured to translate. Translational attachments 610 may be configured to allow translation of some support rails 608 relative to other support rails 608.

The one or more OPA assemblies 602 may be optically coupled to one or more laser energy sources 612 (e.g., via one or more optical cables), as well as operatively coupled to a controller 614 configured to control the phase shifters of the OPA to steer and/or shape the beam 604. The controller 614 may be additionally coupled to actuators associated with gantry assembly 600, such as actuators configured to move the OPA relative to a support rail, or actuators configured to move a support rail relative to another support rail. As noted above, in some instances, the controller may comprise a high speed FPGA coupled to the phase shifters to enable high frequency operation and control of the OPA. Further, a controller as described herein may include one or more processors and associated non-transitory processor readable memory or other media storing instructions that when executed by the one or more processors may control the systems and components described herein to perform the disclosed methods and operations.

FIG. 8 depicts one embodiment of an additive manufacturing system 700 including a microlens array 704. Specifically, a microlens array may be combined with an OPA to significantly increase the fill factor. Increasing the fill factor may be associated with more light going into the central lobe. In the embodiment of FIG. 9, one or more optical fibers 702 are coupled to a microlens array 704. The size, shape, and spacing of the optical elements in the micro lens array 704 may be used to affect the amount of interference 706 of the output of the microlens array 704. An additive manufacturing system 700 that includes a microlens array 704 may be associated with an increased fill factor at a far field image plane 708 compared to an additive manufacturing system that does not include a micro lens array. Depending on the desired embodiment, the microlens array may be located downstream from an OPA along an optical path of the system between the OPA and the build surface.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, FPGAs, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

While the present teachings have been described in conjunction with various embodiments and examples, it is not intended that the present teachings be limited to such embodiments or examples. Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. The present teachings encompass various alternatives, modifications, and equivalents, as will be appreciated by those of skill in the art. Accordingly, the foregoing description and drawings are by way of example only.

1. An additive manufacturing system comprising:
a build surface;
one or more laser energy sources;
an optical phased array operatively coupled to the one or more laser energy sources and constructed and arranged to direct laser energy emitted by the one or more laser energy sources towards the build surface, wherein the optical phased array includes one or more phase shifters operatively coupled to the one or more laser energy sources and configured to control a phase of the laser energy emitted by the one or more laser energy sources.

2. The additive manufacturing system of claim 1, further comprising a processor operatively coupled to the optical phased array, wherein the processor is configured to control the position of one or more laser energy beams directed towards the build surface by controlling a phase of the laser energy emitted by the one or more laser energy sources with the optical phased array.

3. The additive manufacturing system of claim 2, further comprising one or more sensors configured to detect the phase of the laser energy emitted from the one or more laser energy sources, and wherein the processor is configured to control the phase of the laser energy emitted from the one or more laser energy sources based at least partly on the detected phase.

4. The additive manufacturing system of claim 1, wherein the optical phased array is configured to scan one or more laser energy beams along the build surface at a speed of at least 10 m/s.

5. The additive manufacturing system of claim 1, wherein the optical phased array comprises a semiconductor substrate having a plurality of waveguides, emitters, and phase shifters formed on the semiconductor substrate.

6. The additive manufacturing system of claim 5, wherein the semiconductor substrate is mounted on a cooling structure configured to remove heat from the semiconductor substrate.

7. The additive manufacturing system of claim 5, wherein the emitters are arranged in a two dimensional array and configured to emit in a direction that is normal to a surface of the substrate.

8. The additive manufacturing system of claim 5, where the emitters are arranged to emit from an edge of the semiconductor substrate.

9. The additive manufacturing system of claim 8, wherein the emitters include multiple edge-emitting structures stacked to form a two dimensional array.

10. An additive manufacturing system comprising:
a build surface;
a plurality of laser energy sources;
an optical phased array operatively coupled to the plurality of laser energy sources and constructed and arranged to direct laser energy emitted by the plurality of laser energy sources towards the build surface, wherein the optical phased array includes a plurality of phase shifters, wherein each of the plurality of laser energy sources is operatively coupled to one or more of the plurality of phase shifters, wherein the plurality of phase shifters are configured to control a phase of laser energy emitted by the plurality of laser energy sources.

11. The additive manufacturing system of claim 10, further comprising a processor operatively coupled to the optical phased array, wherein the processor is configured to control the position of one or more laser energy beams directed towards the build surface by controlling a phase of the laser energy emitted by the plurality of laser energy sources with the optical phased array.

12. The additive manufacturing system of claim 11, further comprising a plurality of sensors configured to detect the phase of the laser energy emitted from the plurality of laser energy sources, and wherein the processor is configured to control the phase of the laser energy emitted from the plurality of laser energy sources based at least partly on the detected phase of the laser energy emitted from the plurality of laser energy sources.

13. The additive manufacturing system of claim 10, wherein the optical phased array is configured to scan one or more laser energy beams along the build surface at a speed of at least 10 m/s.

14. The additive manufacturing system of claim 10, wherein the optical phased array comprises a semiconductor substrate having a plurality of waveguides, emitters, and phase shifters formed on the semiconductor substrate.

15. The additive manufacturing system of claim 14, wherein the semiconductor substrate is mounted on a cooling structure configured to remove heat from the semiconductor substrate.

16. The additive manufacturing system of claim 14, wherein the emitters are arranged in a two dimensional array and configured to emit in a direction that is normal to a surface of the substrate.

17. The additive manufacturing system of claim 14, where the emitters are arranged to emit from an edge of the semiconductor substrate.

18. The additive manufacturing system of claim 17, wherein the emitters include multiple edge-emitting structures stacked to form a two dimensional array.

19. A method for additive manufacturing, the method comprising:
emitting laser energy from a plurality of laser energy sources; and
controlling a phase of the laser energy emitted by each one of the plurality of laser energy sources to control a position of at least one laser beam directed towards a build surface.

20. The method of claim 19, wherein controlling the phase of the laser energy includes controlling the phase of the laser energy with an optical phased array.

21. The method of claim 20, wherein controlling the phase of the laser energy with the optical phased array includes controlling the phase of the laser energy with a plurality of phase shifters.

22. The method of claim 19, further comprising detecting the phase of the laser energy emitted by each of the plurality of laser energy sources and controlling the phase of the laser energy emitted by each of the plurality of laser energy sources based at least partly on the detected phase of the laser energy emitted by each of the plurality of laser energy sources.

23. The method of claim 19, further comprising controlling the phase of the laser energy emitted by each of the plurality of laser energy sources to scan the at least one laser beam along the build surface.

24. The method of claim 23, further comprising scanning the at least one laser beam along the build surface at a speed of at least 10 m/s.

25. An additive manufacturing system comprising:
a build surface;
one or more laser energy sources configured to emit laser energy;
an optical phased array operatively coupled to the one or more laser energy sources, the optical phased array comprising one or more phase shifters operatively coupled to the one or more laser energy sources and configured to control a phase of the laser energy; and
a mirror galvanometer assembly comprising one or more mirrors,
wherein the optical phased array is configured to direct the laser energy towards the mirror galvanometer assembly,
wherein the mirror galvanometer assembly is configured to direct the laser energy towards the build surface.

26. The additive manufacturing system of claim 25, further comprising a processor operatively coupled to the optical phased array and the mirror galvanometer assembly, wherein the processor is configured to control the position of one or more laser energy beams directed towards the build surface by controlling a phase of the laser energy with the optical phased array, and wherein the processor is configured to control the position of one or more laser energy beams directed towards the build surface by controlling an angular position of the one or more mirrors of the mirror galvanometer assembly.

27. The additive manufacturing system of claim 26, further comprising one or more sensors configured to detect the phase of the laser energy emitted from the one or more laser energy sources, and wherein the processor is configured to control the phase of the laser energy emitted from the one or more laser energy sources based at least partly on the detected phase.

28. The additive manufacturing system of claim 25, wherein the optical phased array is configured to scan one or more laser energy beams along the build surface at a speed of at least 10 m/s.

29. The additive manufacturing system of claim 25, wherein the optical phased array comprises a semiconductor substrate having a plurality of waveguides, emitters, and phase shifters formed on the semiconductor substrate.

30. The additive manufacturing system of claim 29, wherein the semiconductor substrate is mounted on a cooling structure configured to remove heat from the semiconductor substrate.

31. The additive manufacturing system of claim 29, wherein the emitters are arranged in a two dimensional array and configured to emit in a direction that is normal to a surface of the substrate.

32. The additive manufacturing system of claim 29, where the emitters are arranged to emit from an edge of the semiconductor substrate.

33. The additive manufacturing system of claim 32, wherein the emitters include multiple edge-emitting structures stacked to form a two dimensional array.

34. A method for additive manufacturing, the method comprising:
emitting laser energy from a plurality of laser energy sources;
controlling a phase of the laser energy emitted by each of the plurality of laser energy sources to control an angle of at least one laser beam relative to a build surface; and
adjusting an angle of one or more mirrors to further control the angle of the at least one laser beam relative to the build surface.

35. The method of claim 34, wherein controlling the phase of the laser energy includes controlling the phase of the laser energy with an optical phased array.

36. The method of claim 35, wherein controlling the phase of the laser energy with the optical phased array includes controlling the phase of the laser energy with a plurality of phase shifters.

37. The method of claim 34, further comprising detecting the phase of the laser energy emitted by each of the plurality of laser energy sources and controlling the phase of the laser energy emitted by each of the plurality of laser energy sources based at least partly on the detected phase of the laser energy emitted by each of the plurality of laser energy sources.

38. The method of claim 34, further comprising controlling the phase of the laser energy emitted by each of the plurality of laser energy sources to scan the at least one laser beam along the build surface.

39. The method of claim 38, further comprising scanning the at least one laser beam along the build surface at a speed of at least 10 m/s.

40. The method of claim 34, wherein adjusting an angle of one or more mirrors includes adjusting angles of a pair of mirrors of a mirror galvanometer assembly.

41. An additive manufacturing system comprising:
a build surface;
one or more laser energy sources configured to emit laser energy;
an optical phased array operatively coupled to the one or more laser energy sources and configured to direct the laser energy towards the build surface, the optical phased array comprising one or more phase shifters operatively coupled to the one or more laser energy sources and configured to control a phase of the laser energy; and
a gantry assembly configured to adjust a position of the optical phased array relative to the build surface.

42. The additive manufacturing system of claim 41, further comprising a processor operatively coupled to the optical phased array and the gantry assembly, wherein the processor is configured to control the position of one or more laser energy beams directed towards the build surface by controlling a phase of the laser energy with the optical phased array, and wherein the processor is configured to control the position of one or more laser energy beams directed towards the build surface by controlling the position of the optical phased array relative to the build surface y.

43. The additive manufacturing system of claim 42, further comprising one or more sensors configured to detect the phase of the laser energy emitted from the one or more laser energy sources, and wherein the processor is configured to control the phase of the laser energy emitted from the one or more laser energy sources based at least partly on the detected phase.

44. The additive manufacturing system of claim 41, wherein the optical phased array is configured to scan one or more laser energy beams along the build surface at a speed of at least 10 m/s.

45. The additive manufacturing system of claim 41, wherein the optical phased array comprises a semiconductor substrate having a plurality of waveguides, emitters, and phase shifters formed on the semiconductor substrate.

46. The additive manufacturing system of claim 45, wherein the semiconductor substrate is mounted on a cooling structure configured to remove heat from the semiconductor substrate.

47. The additive manufacturing system of claim 45, wherein the emitters are arranged in a two dimensional array and configured to emit in a direction that is normal to a surface of the substrate.

48. The additive manufacturing system of claim 45, where the emitters are arranged to emit from an edge of the semiconductor substrate.

49. The additive manufacturing system of claim 48, wherein the emitters include multiple edge-emitting structures stacked to form a two dimensional array.

50. A method for additive manufacturing, the method comprising:
emitting laser energy from a plurality of laser energy sources;
controlling a phase of the laser energy emitted by each of the plurality of laser energy sources to control an angle of at least one laser beam relative to a build surface; and
adjusting a position of the plurality of laser energy sources relative to the build surface.

51. The method of claim 50, wherein controlling the phase of the laser energy includes controlling the phase of the laser energy with an optical phased array.

52. The method of claim 51, wherein controlling the phase of the laser energy with the optical phased array includes controlling the phase of the laser energy with a plurality of phase shifters.

53. The method of claim 50, further comprising detecting the phase of the laser energy emitted by each of the plurality of laser energy sources and controlling the phase of the laser energy emitted by each of the plurality of laser energy sources based at least partly on the detected phase of the laser energy emitted by each of the plurality of laser energy sources.

54. The method of claim 50, further comprising controlling the phase of the laser energy emitted by each of the plurality of laser energy sources to scan the at least one laser beam along the build surface.

55. The method of claim 54, further comprising scanning the at least one laser beam along the build surface at a speed of at least 10 m/s.

56. The method of claim 50, wherein adjusting a position of the plurality of laser energy sources relative to the build surface includes adjusting a position of the plurality of laser energy sources relative to the build surface with a gantry assembly.
